(19) United States
(12) Patent Application Publication
(10) Pub. No.: US 2024/0101014 A1
(43) Pub. Date: Mar. 28, 2024

(54) LOAD-CARRIER VEHICLE

(71) Applicant: Volvo Autonomous Solutions AB, Göteborg (SE)

(72) Inventor: Oskar NORESSON, Göteborg (SE)

(73) Assignee: Volvo Autonomous Solutions AB, Göteborg (SE)

(21) Appl. No.: 18/448,610

(22) Filed: Aug. 11, 2023

(30) Foreign Application Priority Data
Sep. 23, 2022 (EP) 22197325.8

(51) Int. Cl. B60P 1/26

(52) U.S. Cl. CPC B60P 1/26

(57) ABSTRACT

A load-carrier vehicle includes a load container; and a visual sensor device arranged at an upper part of the load container, wherein the visual sensor device is arranged to monitor an upper load level of the load container and detect an object present at the upper load level.

### TECHNICAL FIELD

The invention relates to a load-carrier vehicle comprising a load container and a visual sensor device arranged to detect an object present at an upper load level. The invention also relates to methods for controlling a system comprising a load-carrier vehicle of the above type.

### BACKGROUND

When loading e.g. crushed stone or similar into a load container of a load-carrier vehicle, such as an articulated hauler, it is generally important to make sure the load is not too large or too unevenly distributed so as to prevent that the loaded material is located above an upper load level at or above an upper part of the load container (although it may be acceptable that a small portion of the load is located above the upper load level). When the load-carrier vehicle drives off after loading, there is a significant risk that material located above the upper load level will fall off, both when starting the vehicle and at a later stage during the transport. Material that has fallen off to the ground may cause damage to other vehicles running into the dropped material or may prevent vehicles form passing by. In addition, dropped load must normally be taken care of, which generates additional work.

Accordingly, it is a desire to avoid dropping load and thus also to avoid loading a too large and/or unevenly distributed load of material into a load container of a load-carrier vehicle. It is also a desire to try to observe whether loaded material is dropped while driving the loaded load-carrier vehicle so that the dropped load can be taken care of if needed before it causes any damage or other problem. This is normally handled, as good as it can, manually by humans. For instance, when a wheel loader is used for loading the load-carrier vehicle, an operator of the wheel loader can check whether the size and shape of the load is acceptable. Detecting drop of load while driving is more difficult; a driver of the load- carrier vehicle can use side view mirrors to try to detect dropping of load during driving, but a driver cannot continuously focus on the side view mirrors and to see behind a truck or similar is hard or even impossible.

There is an increased interest in using autonomous vehicles in mining applications or at other constructions sites, in particular autonomous load-carrier vehicles such as mining dumpers and various trucks or haulers. The use of such vehicles makes load size/shape and dropping of load an even more significant issue since human interaction is not possible in the same way as for manually operated vehicles.

### SUMMARY

An object of the invention is to provide a load-carrier vehicle that is adapted to handle issues related to large or unevenly distributed loads and the risk of dropping portions of such loads. The invention is in particular useful for autonomous vehicles but also useful for manually operated vehicles. A further object is to provide methods for controlling a system comprising such a load-carrier vehicle.

The load-carrier vehicle of this disclosure comprises: a load container; and a visual sensor device arranged at an upper part of the load container, wherein the visual sensor device is arranged to monitor an upper load level of the load container and detect an object present at the upper load level.

The load-carrier vehicle is typically a mining dumper, articulated hauler or truck having a load container (sometimes called bucket) with an open upper side and with a rectangular form at least at the upper part thereof. The vehicle may be autonomous or manually operated, in which case it typically is provided with a driver's cab.

The visual sensor device may typically include a LIDAR sensor arranged at an upper rim of the load container, for instance in a corner of the load container to reduce a working angle to 90° . Several sensors of LIDAR or other type may be included in the sensor device.

A light emitting unit, typically a pulsed laser, may be arranged to scan the upper load level, which typically forms a flat plane at the upper part of the load container close to the upper rim thereof. A LIDAR sensor is capable of detecting objects in a monitored layer or area, and such a sensor is normally also capable of determining a distance to a detected object and the size (or at least a width) of the detected object.

The upper load level may be horizontally limited by the load container by arranging the sensor inside the load container at some distance below the upper rim (or by arranging the sensor so that it can “look into” the container through a sensor window at some distance below the upper rim). Alternatively, the upper load level may be flush with or slightly above the upper rim of the load container. In such a case objects located beyond the load container will not be considered by the visual sensor device. In any case, objects, i.e. a portion of the load, such as a stone or some crushed stones, present at the upper load level will be detected by the device. Such a detection triggers a signal from the visual sensor device and that signal can be used in different ways. Also removal or lateral movement of an object present at the upper load level may trigger a signal that can be used in different ways.

A signal from the visual sensor device may be transmitted to a central control system or, possibly via the central control system, to one or more other vehicles that in some way is/are connected to the load-carrier vehicle. If the load-carrier vehicle is a manually operated vehicle, the signal may be used to notify the operator of the same vehicle, for instance as an additional safety measure in case the operator has not noted dropping or movement of load when checking using the side view mirrors.

As described further below, the visual sensor device is, however, primarily advantageous for autonomous load-carrier vehicles. In an example, the detection signal is transmitted to an operator of a wheel loader used for loading the load-carrier vehicle. The signal may be transmitted directly to a receiving unit arranged in the wheel loader and a control system of the wheel loader may notify the operator. The signal may also be transmitted via a central control system. This may be used as an additional safety measure in case the wheel loader operator does not note that the load becomes too large (high) or is too unevenly distributed.

In a further example, the visual sensor device might detect presence or motion of an object and generate a signal while the (loaded) autonomous load-carrier vehicle is moving between a loading position and an unloading position. Such a signal indicates a possible drop of load. By registering also the position of the load-carrier vehicle at the point of time when the detection signal was generated, which can be done using positioning data (e.g. GPS) for the load-carrier vehicle, it becomes possible to gain knowledge also on the geographic position for the possible load drop. Various measures can then be taken, such as warning other vehicles approaching that geographic position and/or let someone take a look manually at the possible load drop location.

In an embodiment, the visual sensor device comprises a light-emitting unit configured to distribute light over the upper load level. As an example, the light-emitting unit may comprise a pulsed laser source and a rotatable mirror allowing the light from the laser to scan a plane forming the upper load level. However, other structures are also possible.

In an embodiment, the visual sensor device comprises a sensor unit configured to detect light that has been emitted from the light-emitting unit and thereafter been reflected or backscattered from an object present at the upper load level. Various photodetectors may be used.

In an embodiment, the visual sensor device is configured to determine a position of an object present at the upper load level and/or to at least approximately determine a size of an object present at the upper load level. The position of the detected object (in relation to the sensor device) may be determined by determining the distance and direction to the object. The direction may be known from e.g. an angle of the rotatable mirror of the light- emitting unit and the distance can be obtained by recording the time between transmitted and reflected/backscattered pulses and by using the speed of light to calculate the distance travelled. The width and thus the approximate size of the object may be obtained from the scanning angle within which the object is detected.

The visual sensor device typically includes, or is connected to, control circuitry configured to control operation of the device and handle the data sensed by the device. For instance, the control circuitry may be configured to ignore sensed data that indicate presence of an object located further away than a threshold distance (e.g. a diagonal of the load container) and it may be configured to display data and generate an alarm signal in different ways.

In an embodiment, the upper load level forms a substantially flat plane at the upper part of the load container.

In an embodiment, the load container comprises at least one corner at the upper part thereof, wherein the visual sensor device is arranged in said corner. This reduces the scan angle, typically to 90° , compared to if the visual sensor is arranged e.g. in the middle of an upper front part of the load container.

In an embodiment, the visual sensor device is a LIDAR sensor.

In an embodiment, the load-carrier vehicle is a mining dumper, articulated hauler or truck.

In an embodiment, the load-carrier vehicle is an autonomous vehicle.

In an embodiment, the load-carrier vehicle is provided with a control and communication circuitry configured to transmit, in a wire-less manner, data sensed by the visual sensor device to a receiving unit not arranged on the load-carrier vehicle. As further described below, the receiving unit may be arranged in another vehicle or be connected to (or form part of) a central control system. The receiving unit may also be e.g. a mobile phone.

The invention also relates to a method for controlling a system comprising a load-carrier vehicle according to above, wherein the method comprises: transmitting data sensed by the visual sensor device to a receiving unit arranged on a loader vehicle used for loading the load-carrier vehicle when the load-carrier vehicle is set in a loading position; and notifying a driver of the loader vehicle in case an object present at the upper load level has been detected before the load-carrier vehicle has started to drive away from the loading position. The loader vehicle receiving unit may be connected to a control system of the loader vehicle or form a separate unit. Notification to the loader vehicle driver may be effected in different ways, such as an alarm signal on a display.

The invention also relates to a further method for controlling a system comprising a load- carrier vehicle according to above, wherein the further method comprises: moving the load- carrier vehicle and, if detecting that an object is present at the upper load level during motion of the load-carrier vehicle, registering a position of the load-carrier vehicle at a point of time when the object was detected so as to register a position of a possibly dropped load.

In an embodiment of the further method it comprises: communicating said position to other vehicles so as to allow said other vehicles to adapt their movements or actions in response to the position of the possibly dropped load.

The invention also relates to a control circuitry for controlling a system comprising a load- carrier vehicle according to above, wherein the control unit is configured to perform any of the methods above.

### BRIEF DESCRIPTION OF THE DRAWINGS

With reference to the appended drawings, below follows a more detailed description of embodiments of the invention cited as examples.

FIG. 1 shows a schematic side view of a load-carrier vehicle according to the present disclosure.

FIG. 2 shows a top view of the load carrier vehicle of FIG. 1.

FIG. 3 shows a schematic side view of a load container suitable for a load-carrier vehicle according to the present disclosure.

### DETAILED DESCRIPTION OF EXAMPLE EMBODIMENTS OF THE INVENTION

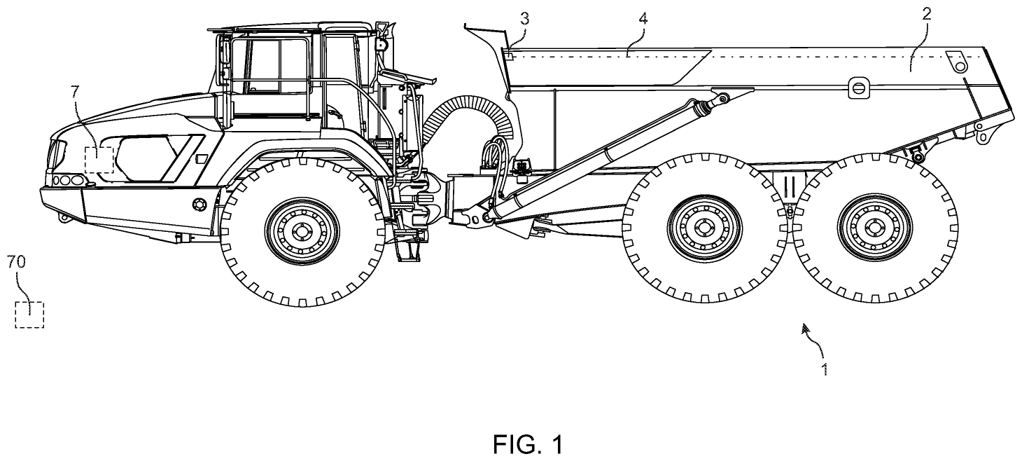

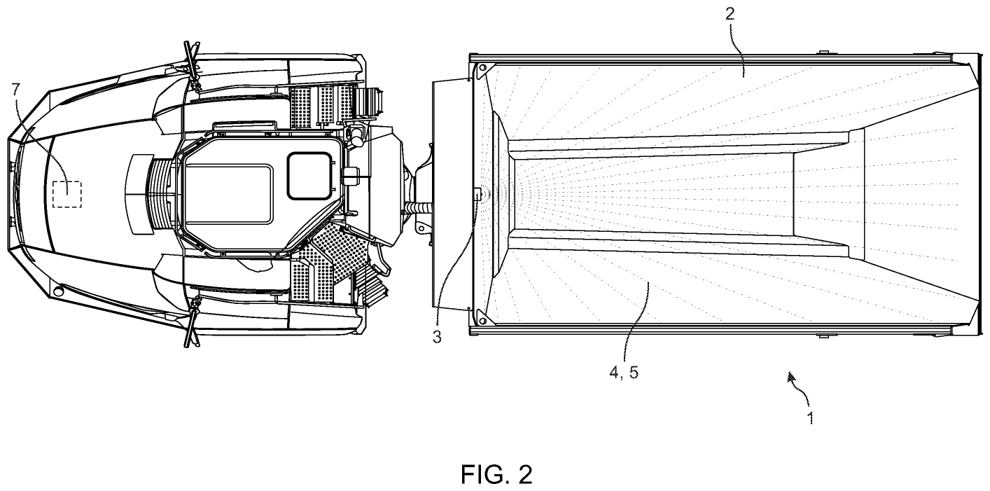

FIG. 1 shows a schematic side view of a load-carrier vehicle 1 according to the present disclosure. FIG. 2 shows a top view of the load-carrier vehicle of FIG. 1. The vehicle is in this example an autonomous articulated hauler.

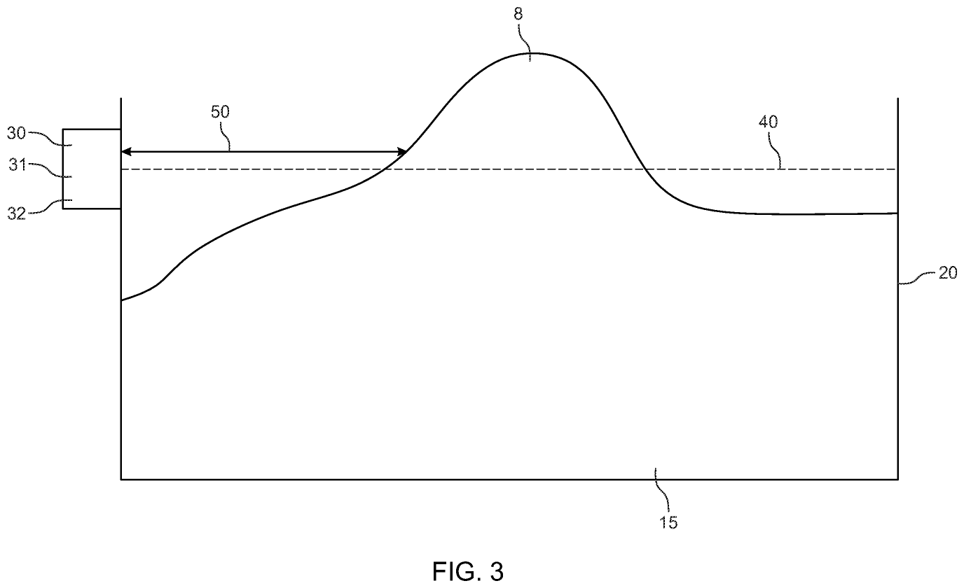

As shown in FIGS. 1-2, the load-carrier vehicle 1 comprises a load container 2 and a visual sensor device 3 arranged at an upper part of the load container 2. The visual sensor device 3 is in this example a LIDAR sensor and it is arranged to monitor an upper load level 4 of the load container 2 and detect an object 8 (see FIG. 3) present at the upper load level 4. The LIDAR sensor 4 emits light, indicated as lines 5 in FIG. 2, in a layer that defines the upper load level 4.

FIG. 3 shows a schematic side view of another load container 20 that may be arranged on a load-carrier vehicle, such as the vehicle 1 shown in FIGS. 1-2. The load container 20 is provided with a visual sensor device 30 similar to the device 3 in FIGS. 1-2, i.e. a LIDAR sensor. FIG. 3 indicates that the visual sensor device 30 comprises a light-emitting unit 31 configured to distribute light 50 over the upper load level 40, and that it further comprises a sensor unit 32 configured to detect light that has been emitted from the light-emitting unit 31 and thereafter been reflected or backscattered from the object 8 present at the upper load level 40. The arrow 50 indicates both emitted and reflected or backscattered light. Light-emitting units and sensor units are standard components in LIDAR sensor and other visual sensor devices so these components are therefore not shown in any detail.

The object 8 in FIG. 3 is a top peak in a load 15 of gravel. A portion of the load protrudes upwards through the upper load level 40, i.e. the object 8 is present at the upper load level 40. This is detected by the LIDAR sensor 30. The load 15 may consist of any material, typically stones, crushed stones, gravel or similar.

The visual sensor device 3, 30 may be configured to determine a position of the object 8 in relation to the sensor device 3, 30 (and thus in relation to the load container 2, 20). It may also at least approximately determine a size of the object 8 by determining its width.

More than one visual sensor device 3, 30 may be arranged at the load container 2, 20. A single visual sensor device 3, 30 may be arranged in different positions, for instance at a front side of the load container 2 as indicated in FIGS. 1-2. As an alternative, the visual sensor device 3, 30 may be arranged in a corner of the load container 2, 20. This reduces the required field-of-view for the visual sensor device 3, 30 to 90° (from 180° in the example shown in FIG. 2).

As indicated in FIGS. 1-3, the upper load level 4, 40 forms a substantially flat plane at the upper part of the load container 2, 20.

As indicated in FIG. 1, the load-carrier vehicle 1 is further provided with a control and communication circuitry 7 configured to transmit, in a wire-less manner, data sensed by the visual sensor device 3, 30 to a receiving unit 70 not arranged on the load-carrier vehicle 1. Wire-less communication between vehicles and various control systems is well known as such. The receiving unit 70 may be arranged in another vehicle, e.g. a wheel loader used for loading the load-carrier vehicle 1, or it may be connected to or form part of some central control system used for controlling a system of vehicles. The term “sensed data” is not limited to data provided by the sensor unit 32 of the device 3, 30 but includes any data signal from the visual sensor device 3, 30, such as detailed data showing information of the object 8 or a simple signal saying only that an object 8 has been detected to be present in the upper load level 4.

An example of a method for controlling a system comprising the load-carrier vehicle 1 comprises:
transmitting data sensed by the visual sensor device 3, 30 to a receiving unit 70 arranged on a loader vehicle used for loading the load-carrier vehicle 1 when the load-carrier vehicle 1 is set in a loading position; and
notifying, before the load-carrier vehicle 1 has started to drive away from the loading position, a driver of the loader vehicle in case an object 8 present at the upper load level 4, 40 has been detected.

As mentioned previously, the details of the method can be carried out in different ways.

Another example of a method for controlling a system comprising the load-carrier vehicle 1 comprises:
moving the load-carrier vehicle 1, e.g. from the loading position to an unloading position, and if detecting that an object 8: i) is present at or enters the upper load level 4, 40; ii) moves within the upper load level 4, 40; and/or iii) leaves the upper load level 4, 40, during motion of the load-carrier vehicle 1:
registering a position of the load-carrier vehicle 1 at a point of time when the presence or motion of the object 8 was detected so as to register a position of a possibly dropped load; and
communicating said position to other vehicles so as to allow said other vehicles to adapt their movements or actions in response to the position of the possibly dropped load.

The position of the load-carrier vehicle 1 is normally easily established by means of GPS equipment or similar arranged onboard.

A control circuitry, such as a central control system, may be used for controlling a system comprising the load-carrier vehicle 1. Such a control circuitry can be used to perform the methods described above.

The number of LIDAR hits on the object can be used to determine the severity of the situation. Several hits could equal a potentially bigger dropped object and therefore a more serious issue, whereas few or a single hit could equal a small rock which could possibly be allowed to be ignored by the system.

The system could further be combined with a position within a map used for localization. By combining the dropped load detecting with the vehicle's position within a map, a POI (point of interest) can be added to the map at that location, prompting other vehicles to approach that area with reduced speed or avoid the area completely. The next vehicle to approach the POI could then use its obstacle detection system to check if the load was actually dropped or not. If the load proves to be an issue, the vehicle can call for help to remove the object. If no/insignificant load is detected the POI can be removed from the map.

It is to be understood that the present invention is not limited to the embodiments described above and illustrated in the drawings; rather, the skilled person will recognize that many changes and modifications may be made within the scope of the appended claims.

1. A load-carrier vehicle comprising:
a load container; and
a visual sensor device arranged at an upper part of the load container, wherein the visual sensor device is arranged to monitor an upper load level of the load container and detect an object present at the upper load level.

2. The load-carrier vehicle according to claim 1, wherein the visual sensor device comprises a light-emitting unit configured to distribute light over the upper load level.

3. The load-carrier vehicle according to claim 2, wherein the visual sensor device comprises a sensor unit configured to detect light that has been emitted from the light-emitting unit and thereafter been reflected or backscattered from an object present at the upper load level.

4. The load-carrier vehicle according to claim 1, wherein the visual sensor device is configured to determine a position of an object present at the upper load level and/or to at least approximately determine a size of an object present at the upper load level.

5. The load-carrier vehicle according to claim 1, wherein the upper load level forms a substantially flat plane at the upper part of the load container.

6. The load-carrier vehicle according to claim 1, wherein the load container comprises at least one corner at the upper part thereof, wherein the visual sensor device is arranged in said corner.

7. The load-carrier vehicle according to claim 1, wherein the visual sensor device is a LIDAR sensor.

8. The load-carrier vehicle according to claim 1, wherein the load-carrier vehicle is a mining dumper, articulated hauler or truck.

9. The load-carrier vehicle according to claim 1, wherein the load-carrier vehicle is an autonomous vehicle.

10. The load-carrier vehicle according to claim 1, wherein the load-carrier vehicle is provided with a control and communication circuitry configured to transmit, in a wire-less manner, data sensed by the visual sensor device to a receiving unit not arranged on the load-carrier vehicle.

11. Method for controlling a system comprising a load-carrier vehicle according to claim 1, the method comprising:
transmitting data sensed by the visual sensor device to a receiving unit arranged on a loader vehicle used for loading the load-carrier vehicle when the load-carrier vehicle is set in a loading position; and
notifying a driver of the loader vehicle in case an object present at the upper load level has been detected before the load-carrier vehicle has started to drive away from the loading position.

12. Method for controlling a system comprising a load-carrier vehicle according to claim 1, the method comprising:
moving the load-carrier vehicle and, if detecting that an object: i) is present at or enters the upper load level; ii) moves within the upper load level; and/or iii) leaves the upper load level, during motion of the load-carrier vehicle,
registering a position of the load-carrier vehicle at a point of time when the presence or motion of the object was detected so as to register a position of a possibly dropped load.

13. Method according to claim 12, the method further comprising:
communicating said position to other vehicles so as to allow said other vehicles to adapt their movements or actions in response to the position of the possibly dropped load.

14. A control circuitry for controlling a system comprising a load-carrier vehicle to, the control unit being configured to perform the method according to claim 11.
